(19) United States
(12) Patent Application Publication
(10) Pub. No.: US 2009/0126553 A1
(43) Pub. Date: May 21, 2009

(54) STRINGED INSTRUMENT WITH COLOR-CODED FRETBOARD AND METHOD OF USING SAME

(75) Inventor: Patrick MURRAY, Marriottsville, MD (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Pat Murray Guitar Company

(21) Appl. No.: 12/212,459

(22) Filed: Sep. 17, 2008

Related U.S. Application Data
(60) Provisional application No. 60/960,142, filed on Sep. 17, 2007.

(51) Int. Cl. G10G 1/02

(52) U.S. Cl. 84/485 R

(57) ABSTRACT

The present invention relates to the use of multi-colored indicators on a stringed instrument to guide the user in proper finger placement on the fretboard or fingerboard for selected musical notes or chords. The indicators are color-coded to correspond to the user's fingers, and the user may also attach indicators on his or her fingers or hand for further guidance. The indicators display colors corresponding to correct finger placement for chosen notes or chords, and the invention may also allow the indicators to display a series of notes or chords, such as may comprise an entire song. The invention may also include indicators to designate which string(s) should be played.

### CROSS REFERENCE TO RELATED APPLICATIONS

This application claims priority under 35 U.S.C. § 119(e) from U.S. Provisional Patent Application No. 60/960,142, filed on Sep. 17, 2007, which is incorporated herein by reference.

### STATEMENT REGARDING SPONSORED RESEARCH OR DEVELOPMENT

Not Applicable.

### REFERENCE TO SEQUENCE LISTING

Not Applicable.

### BACKGROUND OF THE INVENTION

1. Field of the Invention

The present invention relates generally to educational systems and apparatus for musical instruments, and more particularly to stringed instruments with displays to show fingering operations for the production of musical notes or chords.

2. Description of Related Art

Beginning students—and especially young students or those with learning disabilities—may approach learning to play a musical instrument with a certain level of enthusiasm that is beneficial to both the student and teacher. In many cases, this enthusiasm quickly fades as the complexities of the instrument appear overwhelming and the student is unable to properly manipulate the instrument. Such scenarios are especially likely for students of stringed instruments, such a guitar or violin, where the combination of learning proper fingerings and reading music can be especially daunting. Thus, it is a common goal for music teachers to be able to teach students the basic steps for playing a stringed instrument while progressing quickly enough to maintain the students' enthusiasm and encourage further progress.

Known instruction methods include the use of chord charts. Chord charts for stringed instruments can be confusing, especially for young students with limited attention spans. While there are several different types of fingering charts, each generally has the same disadvantage of requiring a student to translate from a two-dimensional representation onto a live instrument. This translation from paper (or screen) to the physical instrument can be a primary obstacle for students and teachers looking to quickly achieve a basic skill set that allows the student to play even the simplest kinds of music.

Educational systems with small lights located in the fingerboard of a stringed instrument have been used to help students identify finger locations for particular musical chords or notes. However, these systems have generally used monochromatic lights that may indicate necessary finger locations. Such systems do not indicate which specific finger should be place at each indicated location; nor so these systems indicate which specific strings should be played for a selected chord.

Thus, there exists a need in the art for an educational system for stringed instruments that allows a student or teacher to identify proper finger locations, finger arrangements, and string selections for musical chords or notes without requiring the translation from an instruction sheet.

### SUMMARY OF THE INVENTION

The present invention meets the aforementioned needs by providing an educational stringed instrument that includes color-coded lights to indicate finger placement and/or string selection for selected musical chords or notes. The user may select a desired note or chord using a selection switch that may located on the instrument or in remote communication with the instrument. The user may also select a series of notes or chords including phrases or complete songs that can be downloaded to a controller located on the instrument or in remote communication with the instrument. Multi-colored lights are located on the neck of the instrument below each string. In response to a chord or note selection, lights can be illuminated in predetermined locations and colors to identify proper finger placement for the selected musical note or chord. Optionally, the invention also includes color indicators for the fingers of the user so that proper finger placement for a pre-selected note or chord may be achieved by matching a finger color to a corresponding light color.

Thus, in one embodiment, the invention provides an educational stringed instrument that includes an instrument neck including a fretboard with a plurality of strings extending longitudinally above the neck. The fretboard includes raised transverse frets spaced longitudinally along the neck to indicate fingering locations on the strings for playing musical chords. The neck includes a set of multi-colored lights located within at least one of the frets and below each of the strings. The instrument also includes a control circuit for controlling the illumination and color of each of the multi-colored lights. The control circuit is in communication with a selection switch, wherein the selection switch indicates a plurality of musical notes or chords that can be selected by a user such that selection of a musical chord corresponds to a predefined illumination and color scheme for the set of multi-colored lights. The control circuit may additionally or alternately be in communication with a programmable chip to which the user may download a series or notes or chords, including complete songs. In a similar embodiment for string instruments without frets, the lights may be located in a neck that includes a fingerboard rather than a fretboard.

The present invention, in another embodiment, may be retrofit onto a conventional stringed instrument. In this embodiment, the invention provides a kit for implementing a color-coded instruction system on a stringed instrument. The kit includes a support matrix supporting a set of multi-colored lights. The support matrix is configured to adhere or otherwise be secured to the neck of the stringed instrument such that at least one of the set of multi-colored lights is positioned under each string of the instrument. The kit also includes a control circuit for controlling the illumination and color of each of the multi-colored lights. As in the above embodiment, the control circuit is in communication with a selection switch. The kit may also include a power source, such as a small battery or an electrical connection.

Embodiments of the invention may further include color indictors for the fingers of the user. Color indictors may be in the form of gloves with different colored fingers, finger-tip covers, finger-nail tabs, nail-polish, stickers or other adhesives, dyes, bands, and the like.

In another embodiment of the invention, an instruction system for learning to play a stringed instrument is provided. The system includes a stringed instrument that includes a set of multi-colored lights with at least one light located beneath each of the strings. The instrument also includes a control circuit for controlling the illumination and color of each of the multi-colored lights. The control circuit is in communication with the selection switch and/or programmable chip and controls the multi-colored lights according to the desired notes or chords as described above. The system further includes a color indicators for the fingers of a user such that each finger may correspond to a separate color. Each of the multi-colored lights can display a separate color corresponding to each color-coded finger to facilitate proper finger placement for the selected note or chord.

In a further embodiment of the invention, a method of instruction for learning to play a stringed instrument is provided. The method includes the steps of (1) providing a stringed instrument capable of identifying proper finger placement for musical notes or chords with color-coded lights; (2) identifying particular fingers of a student to be associated with each light color; (3) selecting a desired musical note or chord to play on the stringed instrument; and (4) identifying finger placement for a selected a musical note or chord using the color-coded lights. Optionally, an additional step includes identifying which stings are to be played for the selected musical note or chord.

Additional embodiments of the invention may include the use of a display screen or a computer touch screen in the neck of the stringed instrument to replace the multi-colored lights with a multi-colored display for facilitating proper finger placement for the desired note or chord. Similarly a computer display screen or touch screen may be used to display which string or strings should be played.

Embodiments may also include the option to vary the speed of the light or display signal changes. Thus the user is aided in the learning process through the ability to increase or decrease the pace at which the notes/chords change so the user can learn at his or her own pace. This feature also allows the user to vary the tempo of the note and/or chord changes in order to change the tempo of the song being played.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 provides a schematic of a stringed instrument in accordance with an embodiment of the present invention;

FIG. 2 provides a system diagram of the stringed instrument in accordance with an embodiment of the present invention;

FIG. 3 provides an enlarged view of a portion of the stringed instrument of FIG. 1;

FIG. 4 provides a schematic of a chord selection switch in accordance with an embodiment of the present invention;

FIG. 5 provides a cross-section view of the neck of a stringed instrument in accordance with an embodiment of the present invention;

FIG. 6 provides a schematic of a color-coded retrofit system for a conventional stringed instrument in accordance with an embodiment of the present invention;

FIG. 7 provides a schematic of a finger color scheme for use in accordance with certain embodiments of the present invention; and

FIG. 8 provides a method of instruction using a color-coded fretboard in accordance with an embodiment of the invention.

### DETAILED DESCRIPTION OF THE INVENTION

Reference will now be made in detail to the preferred embodiments of the present invention, examples of which are illustrated in the accompanying drawings.

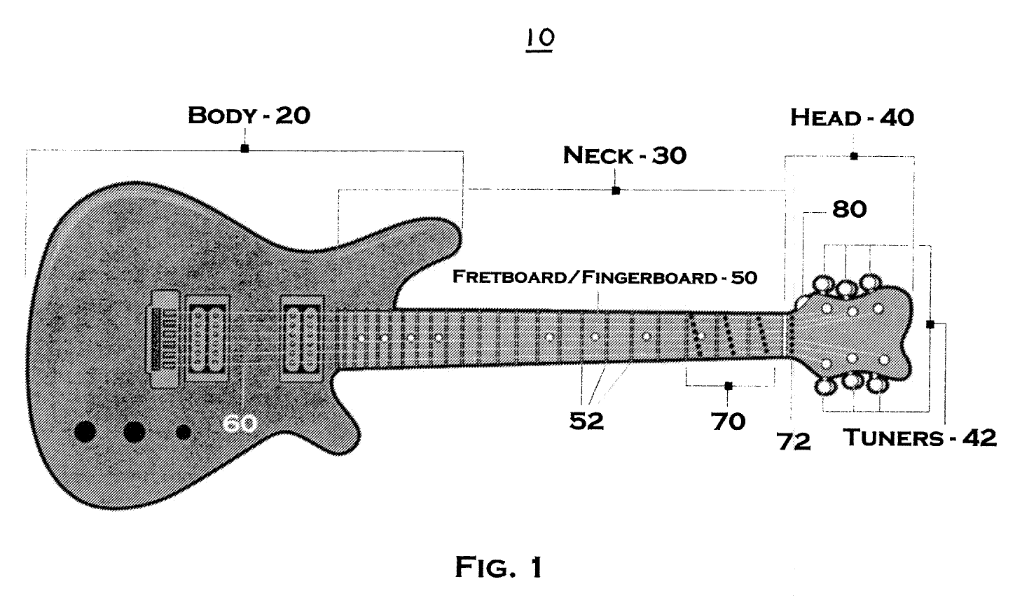

FIG. 1 provides a stringed musical instrument 10 in accordance with one embodiment of the present invention. The instrument includes generally a body 20, a neck 30, and a head 40. A plurality of stings 60 generally span between the body 20 and the head 40 above the neck 30. The neck 30 includes a fretboard 50 (also referred to a fingerboard) which may include raised transverse frets 52 spaced along the length of the fretboard 50. When present, the frets 52 divide the neck 30 into fixed segments at intervals related to a musical framework, such as defined chords. A multi-colored light array 70 is located so that a light is under each string 60 between at least one set of frets 52. The multi-colored light array 70 may be mounted in the neck 30, with the fretboard/fingerboard configured with holes and/or a transparent surface to allow visibility. Alternatively, the multi-colored light array 70 may be mounted directly on or in the fretboard 50. Additionally a second light array 72 is located at or near the end of the fretboard 50. This second set of lights is also located under each string 60 and may be mounted either on the head or neck side of the head-neck interface. In certain embodiments, multi-colored lights 70 are located between only the first 4 frets to allow for instruction for finger-placement of a basic set of chords for beginners. Thus, multi-colored light array 70 may include a total of 24 lights for a typical six-string instrument. It will be understood that lights at fewer or more than 4 frets and on fewer or more than six strings can be used without departing from the spirit or scope of the present invention.

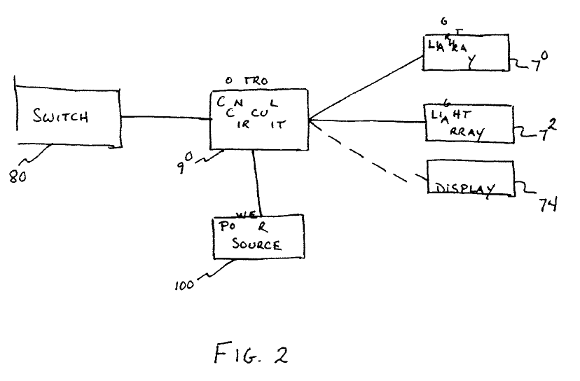

Still referring to FIG. 1, a selection switch 80 is also included in the musical instrument 10. In one embodiment, the selection switch 80 includes indicators on the switch itself of a selected chord. In other embodiments, selection switch 80 may be in communication with an optional display 74 (FIG. 2) to indicate the selected note or chord to the user. The display may be mounted on the body 20, neck 30 or head 40 of musical instrument 10. The selection switch 80 is shown mounted on the side of the head 40, near one of the tuners 42. However, the chord selection switch may be located virtually anywhere on the musical instrument 10 that, preferably, allows for a user to adjust the switch with minimal disruption to the user's playing position.

Embodiments may additionally or alternately include a programmable chip to which the user can download note or chord selections, including complete songs. The programmable chip may be located virtually anywhere on or in the musical instrument 10 or even away from the instrument as long as it is in communication, wired or wireless, with the control circuit 90.

FIG. 2 provides a system diagram of the electronic components of the stringed musical instrument 10 in accordance with one embodiment of the present invention. The selection switch 80 is in communication with a control circuit 90 for controlling both the illumination of and color of each of the light arrays 70 and 72. The selection switch 80 may indicate a plurality of musical notes and/or chords that can be selected by a user such that selection of a musical note or chord corresponds to a predefined illumination and color scheme for the light arrays 70 and 72. The control circuit 90 may also be in communication with the optional display 74 to indicate the selection of selection switch 80.

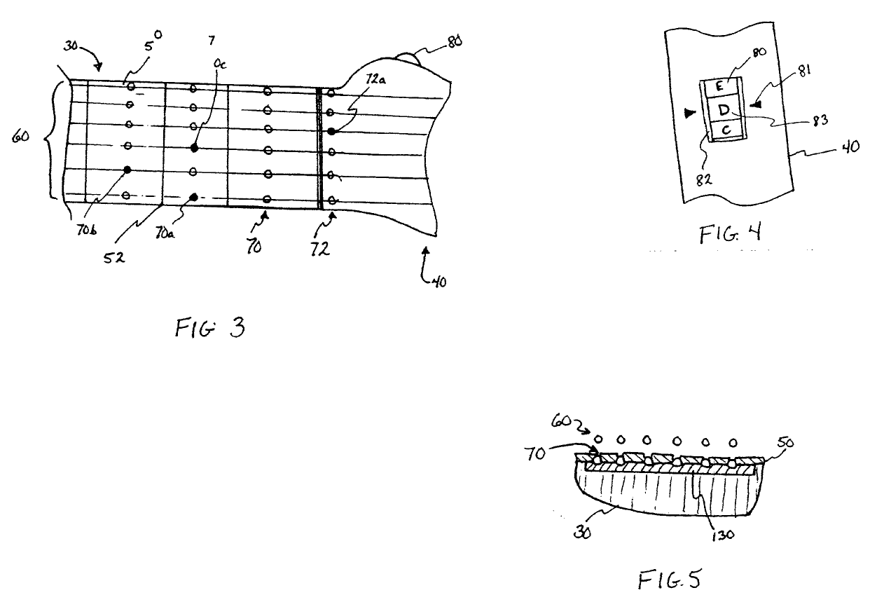

FIG. 3 provides an enlarged view of a portion of the neck 30 and head 40 of the musical instrument 10 shown in FIG. 1, with the selection switch 80 set to a “D” chord. Multi-colored light array 70 can be illuminated in predetermined locations and colors to identify proper finger placement for the selected musical chord. For example, a “D” chord on a typical guitar would include a user placing a finger on the second fret of the first string, the third fret of the second string, and the second fret of the third string. Thus, as shown in FIG. 3, the “D” chord could be indicated by the illumination of three specific lights 70a, 70b, and 70c from light array 70. Each of the illuminated lights 70a, 70b, 70c would be illuminated with a unique color corresponding the finger that should be used to press a particular location. In this particular example, light 70a may be illuminated with a blue light to indicate the second (middle) finger; light 70b may be illuminated with a green light to indicate the third (ring) finger; and light 70c may be illuminated with a red light to indicate the first (index) finger. The light array 72 is used to indicate open strings that are also included when playing the selected musical chord. Thus, for the “D” chord configuration depicted in FIG. 3, light 72a is illuminated to indicate that the fourth string is also to be played as part of the chord. Location of the light array 72 near the head 40 may allow a user to readily recognized both the proper fingering and proper string selection at a single glance.

In certain embodiments, each light in multi-colored array 70 is capable of displaying at least four colors. In one embodiment, the multi-colored array 70 may include multi-colored light emitting diodes (LEDs). Light array 72 may include multi-colored lights or single-colored lights, depending upon the preferred instruction method. In certain embodiments, single color lights would be adequate to indicate only open strings that should be used to play a selected musical chord. In another embodiment, light array 72 may be located under each string on the portion of the fretboard or fingerboard 50 that is near or on the body 20 of the stringed instrument 10. Location of light array 72 near the body 20 of the instrument may allow a user to more readily associate the lights in light array 72 with the strings to be played. In a still further embodiment, a light array 72 may be located at both the head 40 and body 20 ends of the fretboard or fingerboard 50.

FIG. 4 provides a view of the selection switch 80 mounted on a side of the head 40 in accordance with an embodiment of the invention. The selection switch 80 may by a rotary click-switch mounted in a recess 82 in the side of the head 40. The switch contains note and/or chord designators 83 mounted on the switch that align with one or more indictors 81 to identify the selected note or chord, with the selected note or chord corresponding to light arrangements in the neck that identify finger placement for the selected note or chord. In certain embodiments, the selection switch 80 may be mounted on the head, neck, or body of the instrument. In other embodiments, the selection 80 switch may be remotely located from the stringed instrument so that communication between the switch and a control circuit may occur though a wired or wireless connection. In still other embodiments, the selection switch may be rotary knob mounted on the face of the body or head of the instrument. As mentioned above, in some embodiments the selection switch may be augmented or replaced by a programmable chip that can store note/chord sequences or even entire songs.

FIG. 5 provides a cross section of neck 30 showing wiring and light arrangements. In the embodiment of FIG. 5, the neck 30 includes a recess to accommodate multi-colored light array 70. Multi-colored light array 72 may be affixed to a printed circuit board 130 or other surface to allow the array 70 to be inserted as a single component. Fretboard/fingerboard 50 includes holes to allow for each light from light array 70 to be seen. Each light may be flush with or protrude slightly through the fretboard 50 to allow visibility from various angles.

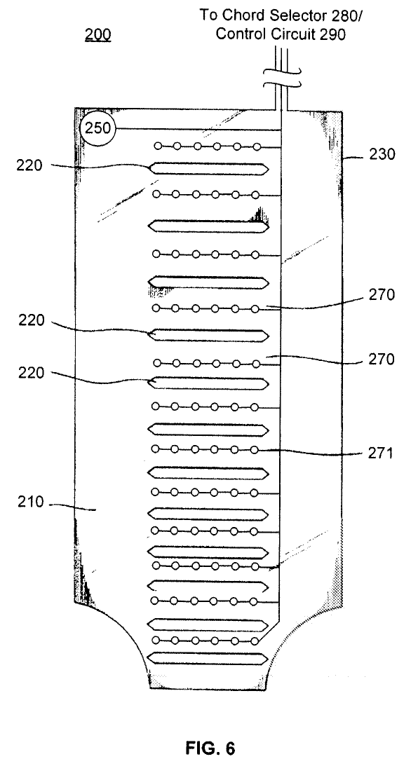

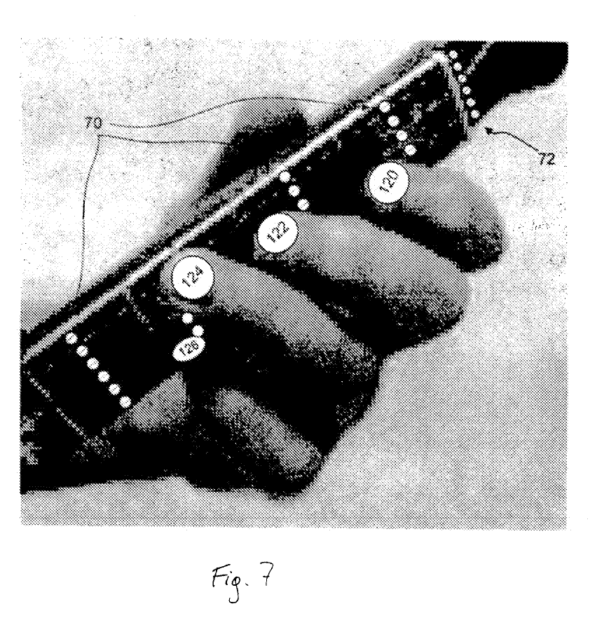

FIG. 6 provides a schematic of a retrofit embodiment of a color-coded instructional system 200 for stringed instruments. The system 200 includes a support matrix 210 that can be secured over the fretboard or fingerboard—and under the strings—of a conventional stringed instrument. The matrix may be a thin flexible material or a thin rigid material suitable for securing a multi-colored light array 270 and a plurality of conductive leads 271. In some embodiments, the support matrix 210 may include fret slots 220 that serve to help properly orient the support matrix 210 on a fretboard of the stringed instrument, such that at least one of the lights of the multi-colored light array 270 is positioned under each string of the instrument. In one embodiment, the underside of the support matrix may include an adhesive surface to secure to the fretboard or fingerboard. In other embodiments, the support matrix 210 may include extensions 230 that wrap around the neck the instrument and adhere to the underside of the neck. The conductive leads 271 may extend from the support matrix 210 wire. The support matrix 210 also includes a control circuit 290 for controlling the illumination and color of each of the lights in the multi-colored light array 270. The control circuit 290 is in communication with a selection switch 280 and/or programmable chip. The selection switch 280 indicates a plurality of musical notes or chords that can be selected by a user such that selection of a musical note or chord corresponds to a predefined illumination and color scheme for the multi-colored light array. The selection switch 280 and/or programmable chip may communicate with the control circuit 290 via a wired connection or via a remote control, such as an infrared signal. In another embodiment, the selection switch 280 may be replaced with a series of push buttons for individual chords. The push buttons may be mounted on the support matrix 210 so as to align with particular fret markers or other locations that would not be inadvertently pressed by the user when playing the instrument. The support matrix may also house a power source 250, such as a small battery or an electrical input connector. The system 200 may further include color indictors for the fingers of the user, as indicated in more detail below with respect to FIG. 7.

Embodiments of the invention also include color indicators for the fingers of the user so that proper finger placement for a pre-selected note or chord may be achieved by matching a finger color to a corresponding light color. As shown in FIG. 7, in one embodiment, the association between a finger and a light-color may be achieved through the use of color-coded labels 120, 122, 124, and 126 that may be removeably affixed to, for example, a user's fingernails. Color-coded labels 120, 122, 124, and 126 may include text to help a student apply the correct color-coded label 120, 122, 124, and 126 to the correct finger. For example, yellow color-coded label 126 may include the text “pinky” on the label to identify proper placement, such that the fourth (or pinky) finger will be associated with a yellow light during use of the stringed instrument 10. Similarly, color-coded labels 120, 122 and 124 may be have colors red, blue and green, respectively, with appropriate text to help identify proper finger association. Color indictors 120, 122, 124 and 126 may be in the form of finger-tip covers, finger-nail tabs, stickers or other adhesives, string, bands, and the like. Other embodiments for associating fingers with colors may include use of a glove or glovelet with different colored finger portions. Still other embodiments may include the use of nail-polish or dyes for fingertips.

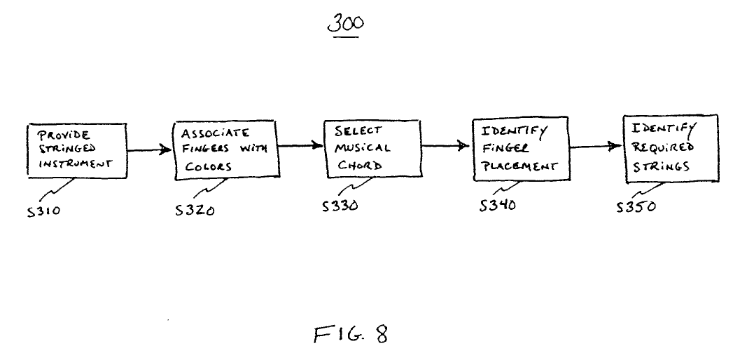

FIG. 8 provides a method 300 of instruction for using a color-coded fretboard in accordance with an embodiment of the invention. The method 300 first includes the step S310 of providing a stringed instrument capable of identifying proper finger placement for musical notes or chords with color-coded lights. Next step S320 includes identifying particular fingers of a student to be associated with each light color. Further, step S330 includes selecting a desired musical note or chord for the stringed instrument. Next step S340 includes identifying finger placement for a selected a musical note or chord using the color-coded lights. Optionally, step S350 includes the step of identifying which strings are to be played for the selected musical note or chord.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A stringed instrument for educational use, comprising:
an instrument neck including a fretboard or fingerboard;
a plurality of strings extending longitudinally above said neck;
a refreshable display located on said instrument neck along said fretboard or fingerboard and below each string, said refreshable display including multi-colored indicators for finger placement; and
a control circuit for controlling the illumination and color of each of said multi-colored indicators.

2. The stringed instrument of claim 1, wherein said fretboard includes raised transverse frets spaced longitudinally along said neck to indicate fingering locations on said strings for playing musical chords and wherein said set of multi-colored indicators are located within at least one of said frets.

3. The stringed instrument of claim 1 further comprising a selection switch in communication with said control circuit, wherein said selection switch includes a plurality of musical notes or chords that can be selected by a user such that selection of a musical note or chord corresponds to a predefined illumination and color scheme for said set of multi-colored indicators.

4. The stringed instrument of claim 1 further comprising a programmable chip in communication with said control circuit, wherein said programmable chip can store a plurality of musical notes or chords that can be selected such that the selection of a musical note or chord corresponds to a predefined illumination and color scheme for said set of multi-colored indicators.

5. The stringed instrument of claim 4, wherein said programmable chip may store a series of musical notes or chords, including song excerpts or complete songs.

6. The stringed instrument of claim 5, wherein the tempo of the series of musical notes or chords is controlled by the user.

7. The stringed instrument of claim 4, wherein said programmable chip is remote from said stringed instrument.

8. The stringed instrument of claim 1, wherein said neck further comprises a set of indicators to indicate an open string for a selected note or chord.

9. The stringed instrument of claim 1, wherein said stringed instrument further comprises a head and a body, said selection switch being mounted on one of said head, neck, or body.

10. The stringed instrument of claim 3, wherein said selection switch is remote from said stringed instrument.

11. The stringed instrument of claim 3, wherein said predefined color scheme includes individual colors that corresponds to particular fingers of said user.

12. The stringed instrument of claim 4, wherein said predefined color scheme includes individual colors that corresponds to particular fingers of said user.

13. The stringed instrument of claim 11, further comprising color markings for particular fingers of said user.

14. The stringed instrument of claim 12, further comprising color markings for particular fingers of said user.

15. The stringed instrument of claim 1, wherein each of said multi-colored indicators can display at least four separate colors.

16. The stringed instrument of claim 1, wherein said refreshable display comprises a set of multi-colored lights, a computer display screen, or a computer touch screen.

17. An instruction system for learning to play a stringed instrument comprising a refreshable display on the neck of a stringed instrument, said refreshable display including color-coded indicators for finger placement; and a control circuit for controlling display of musical notes or chords through said color-coded indicators, wherein said color-coding corresponds to particular fingers of said user.

18. The instruction system of claim 17 further comprising color indicators for the fingers of the user.

19. The instruction system of claim 17, wherein said refreshable display comprises a set of multi-colored lights, a computer display screen, or a computer touch screen.

20. A kit for implementing the color-coded instruction system of claim 16 comprising said refreshable display and said control circuitry.

21. The kit of claim 20 further comprising color indicators for the fingers of the user.

22. A method of instruction for learning to play a stringed instrument comprising the steps of providing a stringed instrument capable of identifying proper finger placement for musical notes or chords with a refreshable display including color-coded indicators; identifying particular fingers of a student to be associated with each color; selecting a desired musical note or chord for the string instrument; identifying finger placement for a selected musical note or chord using the color-coded indicators.

23. The method of instruction of claim 22 further comprising identifying which strings are to be played for the selected musical note or chord.

24. The method of instruction of claim 22, wherein said refreshable display comprises a set of multi-colored lights, a computer display screen, or a computer touch screen.
